(19) United States
(12) Patent Application Publication
(10) Pub. No.: US 2008/0118792 A1
(43) Pub. Date: May 22, 2008

(54) Fuel cell system and driving method thereof

(76) Inventors: Jin-Hong An, Yongin-si (KR); Ri-A Ju, Yongin-si (KR)

Correspondence Address: ROBERT E. BUSHNELL, 1522 K STREET NW, SUITE 300, WASHINGTON, DC, 20005-1202, US

(21) Appl. No.: 11/984,417

(22) Filed: Nov. 16, 2007

(30) Foreign Application Priority Data
Nov. 16, 2006 (KR) 10-2006-0113279

(51) Int. Cl. H01M 8/04

(52) U.S. Cl. 429/13; 429/22; 429/23

(57) ABSTRACT

Disclosed is a fuel cell system for controlling an initial operation of an electrical system by using a fuel cell as a power source and driving method thereof. A fuel cell system, for supplying electrical power with an electrical system, includes a sensing unit disposed in the fuel cell system and sensing the ON-operation of a switch, wherein the switch is disposed in the electrical system and generates a signal for starting the electrical system, and a fuel cell controller for supplying fuel and oxidant with a main body of the fuel cell system when the level of an output signal of the sensing unit is equal to or higher than a reference level, wherein the electrical system is started by supplying electrical power of the fuel cell system with the electrical system after the fuel cell system normally operates.

### CLAIM OF PRIORITY

This application makes reference to, incorporates the same herein, and claims all benefits accruing under 35 U.S.C. §119 from an application earlier filed in the Korean Intellectual Property Office on the 16^{th} of November 2006 and there duly assigned Serial No. 10-2006-0113279.

### BACKGROUND OF THE INVENTION

1. Field of the Invention

The present invention relates to a fuel cell system for controlling an initial operation of an electrical system by using a fuel cell as a power source and driving method thereof.

2. Description of Related Art

With the aid of the recent technical development of electronics and communication, etc., various portable electrical system such as a cellular phone, a personal digital assistant (PDA), a MP3 player, a portable multimedia player (PMP) and a notebook, etc., which are capable of using huge amounts of multimedia information, have come into wide use. Under the circumstance, an apparatus capable of supplying long-time power to a portable electrical system has been also requested in the field of a power supplier. As a power supplier capable of supplying long-time power, a fuel cell has been spotlighted.

A fuel cell is a power generation system that directly converts chemical energy into electric energy by means of an electro-chemical reaction between hydrogen and oxygen. Depending on operating temperature, the fuel cell may be implemented by including a polymer electrolyte membrane fuel cell and a direct methanol fuel cell operating at normal temperature or 100° C. or less, a phosphoric acid fuel cell operating about 150 to 200° C., a molten carbonate fuel cell operating at high temperature of 600 to 700° C., and a solid oxide fuel cell operating at high temperature of 1000° C. or more. These respective fuel cells are basically operated based on the similar principle, but are different in view of types of fuels used, catalysts and electrolytes, etc.

Among others, a direct methanol fuel cell (DMFC) is a fuel cell that uses a polymer membrane conducting hydrogen proton as an electrolyte and directly uses liquefied fuel such as methanol, etc., on an anode. In order to obtain a desired voltage, the DMFC commonly has a structure that several membrane electrode assemblies are stacked. The membrane electrode assemblies have a structure that an anode electrode and a cathode electrode are attached to both sides of the electrolyte membrane. The DMFC does not use a fuel reformer but operates at an operating temperature of 100° C. or below, having an advantage that it is suitable for a structure of a portable or small-sized fuel cell.

A portable electrical system and a fuel cell system are substantially stand-alone apparatus and are fabricated to be independently driven by each controller. For example, it is preferable that the electrical system is fabricated to be used right after a starting. However, it takes a predetermined time, for example, about five to thirty minutes according to the types or the structure of the fuel cell, for the fuel cell system to generate a desired electric power after the system starts, resulting in that the electrical system using the fuel cell system as a power source, should be operated by considering the characteristics of such a fuel cell system. Therefore, the electrical system using the fuel cell system as a power source has a disadvantage that a user first drives the fuel cell system and then drives the electrical system by connecting the fuel cell system to the electrical system after the fuel cell system normally operates.

Meanwhile, one of the methods in order to improve the disadvantage is to modify the portable electrical system so that the fuel cell system is mounted thereon as a part of the electrical system. However, since such a modifying method has to significantly change the design and the constitution of a circuit, etc., of the electrical system, it is difficult to apply such a modifying method.

### SUMMARY OF THE INVENTION

The present invention is proposed to solve the above problems. It is an object of the present invention to provide a fuel cell system capable of easily designing an electrical system using a fuel cell as a power source and improving a user's convenience, by providing a method to easily control initial operation of an electrical system using a fuel cell system as a power source.

In order to accomplish the object, a fuel cell system according to one aspect of the present invention, the fuel cell system, for supplying electrical power to an electrical system, includes a sensing unit disposed in the fuel cell system and sensing the on/off operation of a switch, wherein the switch is disposed in the electrical system and generates a start signal for initiating start of the electrical system and the sensing unit outputs an output signal if the switch is on mode, and a fuel cell controller for supplying fuel and oxidant to a main body of the fuel cell system when the level of the output signal of the sensing unit is equal to or higher than a reference level, wherein the electrical system starts operation by receiving electrical power of the fuel cell system after the fuel cell system normally operates.

The fuel cell system may be coupled to the electrical system by means of power lines and a signal line, wherein the sensing unit detects the output signal generated by the switch and transmitted through the signal line.

A fuel cell system according to another aspect of the present invention, the fuel cell system, for supplying electrical power to an electrical system as a main power source, includes an auxiliary power source for supplying initial electrical power to the electrical system in response to a signal for starting the electrical system wherein the signal is generated by a switch disposed in the electrical system, a sensing unit detecting voltage or current output from the auxiliary power source, and a fuel cell controller for supplying fuel and oxidant to a main body of the fuel cell when the level of voltage or current output transmitted from the sensing unit is equal to or higher than a reference level. The electrical system operates by receiving electrical power of the fuel cell system after the fuel cell system normally operates.

The fuel cell controller may include a logic circuit using flip-flop or a microprocessor.

The switch may include a mechanical switch, an electrical switch or an electro-mechanical switch.

A method for driving a fuel cell system according to another aspect of the present invention is provided. The method, for driving a fuel cell system coupled to an electrical system, includes detecting a signal generated by a switch in order to initiate start of the electrical system, supplying fuel and oxidant to a main body of the fuel cell system when the level of the detected signal is equal to or higher than a reference level, and driving the electrical system by supplying electrical power of the fuel cell system to the electrical system after the fuel cell system normally operates.

A method for driving a fuel cell system according to another aspect of the present invention is provided. The method, for driving a fuel cell system coupled to an electrical system as a main power source, includes detecting voltage or current output from an auxiliary power source in response to a signal generated by a switch in order to start the electrical system wherein the auxiliary power source supplies initial electrical power with the electrical system and fuel cell system, supplying fuel and oxidant to a main body of the fuel cell system when the level of the detected voltage or current output is equal to or higher than a reference level, and driving the electrical system by supplying electrical power of the fuel cell system to the electrical system after the fuel cell system normally operates.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram showing a fuel cell system according to one embodiment of the present invention;

FIG. 2 is a circuit diagram showing a switch operating sensing circuit adoptable on the fuel cell system in FIG. 1;

FIG. 3 is a block diagram showing a fuel cell system according to another embodiment of the present invention; and

FIG. 4 is a circuit diagram showing a current sensing circuit adoptable on the fuel cell system in FIG. 3.

### DETAILED DESCRIPTION OF EXEMPLARY INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

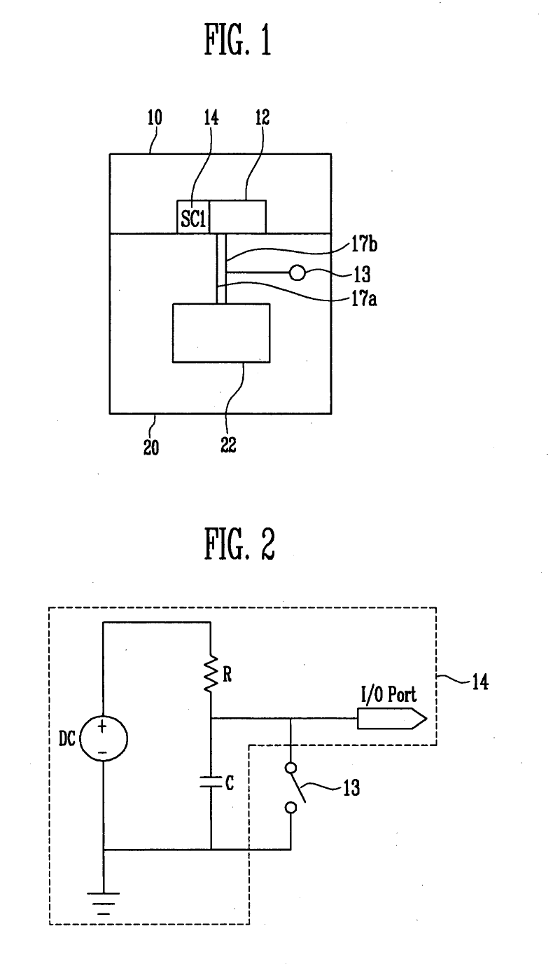

FIG. 1 is a block diagram showing a fuel cell system constructed as one embodiment of the present invention. Referring to FIG. 1, a fuel cell system 10 of the embodiment of the present invention includes a fuel cell controller 12 for controlling the operation of the fuel cell system 10 and a switch-operation sensing unit 14 for sensing ON-operation of a switch 13. Here, an electrical system 20, using the fuel cell system 10 for a power source, includes an electrical system controller 22 for controlling the operation of the electrical system 20 and a switch 13 for generating a signal for starting the electrical system 20. The switch 13 is coupled to the fuel cell controller 12 through the switch-operation sensing unit 14, and is coupled to the electrical system controller 22. In the fuel cell system 10 of the embodiment, the fuel cell controller 12 and the electrical system controller 22 are electrically connected to each 11 other by means of power lines 17a for being supplied with electrical power and a signal line 17b for transferring signals such as a control signal, etc. Also, the electrical system 20 may include an apparatus such as a notebook computer with external terminals to be connected to positive and negative power lines and at least one signal line.

The fuel cell system 10 of the embodiment, first, starts operation in response to a signal generated by a switch 13, which starts or stops the operation of an electrical system 20. Here, starting the fuel cell system 10 includes supplying fuel and oxidant with the main body of the fuel cell system 10. After the predetermined time period passes, the electrical system 20 starts operation. During the predetermined time period, the fuel cell system 10 reaches a normal operation state. The normal operation state of the fuel cell system 10 may include the case that the temperature of the main body of the fuel cell system 10 is between about 80% to about 100% of the predetermined operation temperature. According to the fuel cell system 10, the difficulty of maintenance and management of the fuel cell system 10 and the electrical system 20 due to the difference of characteristics therebetween can be solved. The user's convenience for the electrical system 20 using the fuel cell system 10 for a power source can be improved.

Each element of the fuel cell system 10 will be described in detail. The fuel cell system 10 is a power generation system generating electric energy by means of an electro-chemical reaction between fuel containing hydrogen and oxidizer. The fuel cell system 10 may be constructed to include a main body of a fuel cell actually generating electricity, a fuel/oxidizer supplier for supplying fuel and oxidizer to the main body of the fuel cell, and a fuel cell controller 12 for controlling the supplier.

The main body of the fuel cell uses a polymer membrane having conductivity as an electrolyte, wherein it is preferable that the main body is configured of several membrane electrode assemblies (MEA) having a structure that the polymer membrane is disposed between an anode electrode and a cathode electrode. The main body of the fuel cell may be constructed as a polymer electrolyte fuel cell, a direct methanol fuel cell or a direct formic acid fuel cell, which are suitable for a small size or portable apparatus.

The fuel supplier may include a fuel tank for storing fuel, and a fuel pump for supplying the fuel stored in the fuel tank to the main body of the fuel cell. The oxidizer supplier includes an apparatus for supplying oxidizer such as air or oxygen, etc., to the main body of the fuel cell. An apparatus such as a fan and an air pump, etc., may be further used. Furthermore, the fuel cell system 10 may use the combination of a recycling means capable of reusing a non-reactive fuel and water exhausted from a fuel cell stack by circulating them, and the fuel supplier in order to improve fuel efficiency. The recycling means may includes a heat exchanger, a water-liquid separator exhausting non-desired gas such as carbon dioxide, etc., except the non-reactive fuel and water among fluid exhausted from the main body of the fuel cell, and a mixer for mixing the fuel supplied from the fuel tank with the non-reactive fuel exhausted from the main body of the fuel cell.

The fuel cell controller 12 is an apparatus for controlling the operation of the fuel cell system 10. The fuel cell controller 12 detects a state of the main body of the fuel cell, and performs a preset control routine to control the fuel/oxidizer supplier or the recycling means. In particular, the fuel cell controller 12 of the present invention is constructed so that it detects the operation of the switch 13 through the switch-operation sensing unit 14 by receiving a signal through the signal line 17b from the switch 13. Also, the fuel cell controller 12 is constructed to drive the fuel cell system 10 in response to the detected signal, and then the electrical system 20 starts operation by electrical power supplied from the fuel cell system 10 after a predetermined time period passes. The predetermined time period includes a time period that is required for the fuel cell system 10 to reach a normal operation state. The predetermined time period can be counted by means of a timer that can be included in the fuel cell controller 12. The fuel cell controller 12 may be built by the use of a logic circuit using flip flop or at least one functional component of a microprocessor.

FIG. 2 is a circuit diagram showing a switch-operation sensing circuit, which can be included in the switch-operation sensing unit 14 and can be adoptable on the fuel cell system shown in FIG. 1. Referring to FIG. 2, a switch-operation sensing unit 14 of the embodiment of the present invention detects the operation of the switch 13. The switch-operation sensing unit 14 includes a serial circuit of a resistor element R and a capacitor element C connected to the terminals of an inner power source DC. One terminal of the switch 13 is connected to a terminal of the capacitor element C, and another terminal of the switch 13 is connected to a contact node with the resistor element R and the capacitor element C. The contact node is connected to an I/O port. A signal of the I/O port is transferred to an external or internal input terminal of the fuel cell controller 12.

The switch-operation sensing unit 14 outputs an active high signal when the switch 13 is in an off mode, and outputs an active low signal when the switch 13 is in an on 11 mode. Meanwhile, the switch-operation sensing unit 14 may use existing various switch operating sensing circuits. For example, the present invention may use the switch-operation sensing circuit outputting active high signal when the switch 13 is in an off mode, and outputting active low signal when the switch 13 is in an on mode, by putting the switch 13 in a position of the resistor element R.

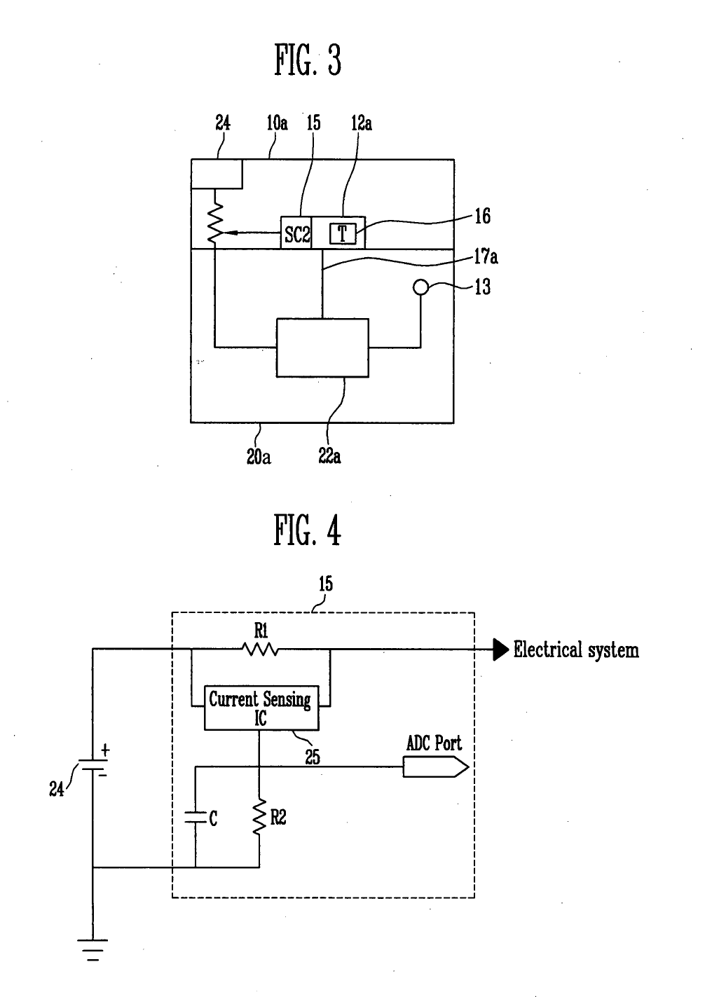

FIG. 3 is a block diagram showing a fuel cell system according to another embodiment of the present invention. Referring to FIG. 3, a fuel cell system 10a according to the embodiment senses a signal generated by means of the operation of a switch 13 in order to start the electrical system 20a, using a fuel cell system 10a as a main power source. The fuel cell system 10a is firstly operated oneself in response to the sensed signal, and then drives the electrical system 20a after a predetermined time. To this end, the fuel cell system 10a includes a sensing unit 15 for sensing voltage or current of electrical power, which is supplied from an auxiliary power source 24 to an electrical system controller 22a for controlling the electrical system 20a in response to the signal generated from the switch 13, and a fuel cell controller 12a for driving the fuel cell system 10a in response to an output signal when the level of the output signal being output from the sensing unit 15 is equal to or higher than the level of a reference signal. Here, the electrical system 20a operates by receiving electrical power of the fuel cell system 10a after the fuel cell system 10a reaches a normal operation states.

In the fuel cell system 10a of the embodiment, the fuel cell controller 12a and the electrical system controller 22a are electrically connected to each other by means of power lines 17a for being supplied with electrical power.

The switch 13 in the embodiment is coupled to the electrical system controller 22a for controlling the electrical system 20a, while the switch 13 in the first embodiment shown FIG. 1 is coupled to the electrical system controller 22a and the fuel cell controller 12a. The switch 13 may include a mechanical switch, an electrical switch and an electromechanical switch.

The auxiliary power source 24, which is for supplying electrical power to balance of plants (BOP) and the fuel cell controller 12a, etc. in the fuel cell system 10a and for supplying electrical power to the electrical system controller 22a, etc. in the electrical system 20a at the time of the starting of the electrical system 20a and, may include an apparatus capable of supplying power, such as a secondary battery and a capacitor, etc. When using the secondary battery or the capacitor for the auxiliary power source 24, the present invention has an advantage of making it possible to charge the auxiliary power source 24 through the fuel cell system 10.

Meanwhile, in order to firstly operate the fuel cell system 10a after the switch 13 operates and then to start the electrical system 20a after a predetermined time period, the fuel cell system 10a of the present embodiment may further include a timer 16 counting a predetermined time in response to the signal of the switch 13. In this case, a control signal for starting the electrical system 20a is transferred from the fuel cell controller 12a to the electrical system controller 22a when the operation of the timer 16 is completed. Also, in the fuel cell system 10a, if the fuel cell system 10a reaches the normal operation condition prior to a predetermined time, the fuel cell controller 12a generates a starting completion signal notifying that the fuel cell system 10a is in a normal driving condition, and the starting completion signal is transferred to the electrical system controller 22a of the electrical system 20a. Upon receiving the starting completion signal, the electrical system 20a starts operation even though it is earlier than the predetermined time schedule. In this case, it is necessary that a signal line is further disposed between fuel cell controller 12a and electrical system controller 22a.

FIG. 4 is a circuit diagram showing a current sensing circuit, which can be included in the sensing unit 15 and can be adoptable in the fuel cell system shown in FIG. 3. Referring to FIG. 4, a sensing unit (SC2) 15 of the embodiment detects current supplied from an auxiliary power source 24 to the electrical system controller 22a. And then, the sensing unit 15 outputs a signal having ADC voltage characteristics depending on the amount of the sensed current. Here, ADC voltage characteristics indicate that an analog signal inputted to the sensing unit 15 is converted and outputted as a digital signal with the corresponding value. The sensing unit 15 includes a first resistor R1 coupled between a positive terminal of an auxiliary power source 24 and the electrical system controller 22a, a current sensing IC 25 of which a first input terminal and a second input terminal are connected to the terminals of the first resistor R1, respectively, and a RC parallel circuit connected between a negative terminal of the auxiliary power source 24 and an output terminal of the current sensing IC 25. The RC parallel circuit is configured of a capacitor C and a second resistor R2. The resistance of the second resistor R2 is set based on the maximum voltage, the peak voltage and the peak current of the current sensing IC 25.

According to the current sensing circuit 15 as shown in FIG. 4, ADC voltage depending on the amount of the current flowing through the first resistor RI is outputted to the ADC port connected to the output terminal of the current sensing IC 25. The maximum of the voltage output from the ADC port may be generally 3.0V and it may be corrected to actual voltage in the fuel cell controller 12a implemented by means of a microcomputer. The ADC port is connected to an input terminal of the fuel cell controller 12a.

As described above, the present invention provides a method to easily control an initial operation of the electrical system using a fuel cell system as a power source, so that it has advantages that an electrical system which wants to use a fuel cell as a power source among the electrical system which is currently being sold can be easily designed, the difficulty of maintenance and management of the fuel cell system and the electrical system due to the difference of characteristics therebetween be solved, and the user's convenience for the electrical system using the fuel cell system as a power source be improved.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel cell system supplying electrical power to an electrical system, the fuel cell system comprising:
a sensing unit disposed in the fuel cell system and sensing an operation of a switch that is disposed in the electrical system and generates a start signal for initiating start of the electrical system, the sensing unit outputting an output signal if the switch is on mode; and
a fuel cell controller for supplying fuel and oxidant to a main body of the fuel cell system when the level of the output signal of the sensing unit is equal to or higher than a reference level, wherein the electrical system starts operation by receiving electrical power from the fuel cell system after the fuel cell system normally operates.

2. The fuel cell system as claimed in claim 1, wherein the fuel cell system is coupled to the electrical system through power lines and a data line, wherein the sensing unit detects the start signal that is generated by the switch and is transmitted through the data line.

3. The fuel cell system as claimed in claim 1, wherein the fuel cell controller includes a logic circuit using flip-flop or a microprocessor.

4. The fuel cell system as claimed in claim 1, wherein the switch includes a mechanical switch, an electrical switch or an electromechanical switch.

5. A fuel cell system for supplying electrical power to an electrical system as a main power source, the fuel cell system comprising:
an auxiliary power source for supplying initial electrical power to the electrical system in response to a signal for starting the electrical system, wherein the signal is generated by a switch disposed in the electrical system;
a sensing unit detecting voltage or current output from the auxiliary power source, the sensing unit outputting an output signal representing the voltage or current output from the auxiliary power source; and
a fuel cell controller for supplying fuel and oxidant to a main body of the fuel cell system when the level of the output signal from the sensing unit is equal to or higher than a reference level, wherein the electrical system operates by receiving electrical power from the fuel cell system after the fuel cell system normally operates.

6. The fuel cell system as claimed in claim 5, wherein the fuel cell system is coupled to the electrical system through power lines.

7. The fuel cell system as claimed in claim 5, wherein the fuel cell controller includes a logic circuit using flip-flop or a microprocessor.

8. The fuel cell system as claimed in claim 5, wherein the switch includes a mechanical switch, an electrical switch or an electromechanical switch.

9. A method for driving a fuel cell system coupled to an electrical system, the method comprising:
detecting a signal generated by a switch in order to initiate start of the electrical system;
supplying fuel and oxidant to the fuel cell system when the level of the detected signal is equal to or higher than a reference level; and
driving the electrical system by supplying electrical power of the fuel cell system to the electrical system after the fuel cell system normally operates.

10. The method as claimed in claim 9, the method further comprising:
delaying the supply of electrical power of the fuel cell system until the fuel cell system normally operates.

11. A method for driving a fuel cell system coupled to an electrical system as a main power source, the method comprising:
detecting voltage or current output from an auxiliary power source in response to a signal generated by a switch in order to start the electrical system;
supplying fuel and oxidant to the fuel cell system when the level of the detected voltage or current output is equal to or higher than a reference level; and
driving the electrical system by supplying electrical power of the fuel cell system to the electrical system after the fuel cell system normally operates.

12. The method as claimed in claim 11, the method further comprising:
delaying the supply of electrical power of the fuel cell system until the fuel cell system normally operates.

13. The method as claimed in claim 11, the method further comprising:
supplying electric power from the auxiliary power source to the electrical system if a switch of the electrical system is on mode.

14. The method as claimed in claim 13, wherein the step of supplying electric power is performed until the fuel cell system normally operates.
